(19) United States
(12) Patent Application Publication
(10) Pub. No.: US 2003/0081988 A1
(43) Pub. Date: May 1, 2003

(54) Rotating gear with limited angular-movement

(76) Inventor: Kuan-Yu Chou, Taipei (TW)

Correspondence Address: BACON & THOMAS, PLLC, 625 SLATERS LANE, FOURTH FLOOR, ALEXANDRIA, VA, 22314

(21) Appl. No.: 09/984,753

(22) Filed: Oct. 31, 2001

(51) Int. Cl. F16D 1/12; F16D 3/00; F16C 11/00

(52) U.S. Cl. 403/113

(57) ABSTRACT

A rotating gear with limited angular movement comprises of a spindle pivotally disposed inside an object, at least one flange disposed on the periphery of one end of the spindle adjacent to the object, and an mobile limiter having a first plate extended from the periphery of one side of the limiter toward the spindle and a second plate extended from the periphery of another side of the limiter toward the object. Thus, while the spindle is rotated, the flange is engaged with the first plate to drive the limiter to rotate until the second plate touches against a stopper disposed on the object, which prevents the spindle from being continuously rotated in a range causing damages.

### BACKGROUND OF THE INVENTION

(a) Field of the Invention

The present invention relates to a rotating gear with limited angular-movement, and more particularly to a gear, which is able to increase the rotating angle and prevent being continuously rotated in a range causing damages.

(b) Description of the Prior Art

A conventional rotating gear enabling an object 1 to be adapted to another object 2 and rotating along the axis of said rotating gear is illustrated in FIG. 1, said rotating gear is comprised of a cylindrical spindle 10 and two objects 1,2. One object 1 is fixed to said spindle 10, and another object 2 has a pivoting base 20 to accommodate said spindle 10 and let said spindle 10 be rotated inside. Thus, said object 1 will be rotated along with said spindle 10.

However, if a circuit board is provided in each of said two objects, and a signal line passing through the spindle 10 is connected to said two objects at its ends, said signal wire between said two objects will continuously wind up while the object 1 is continuously rotated along the axis of said spindle 10, which will cause damages to the signal wire or the connection with said circuit boards and interrupt the transmission between said two circuit boards.

### SUMMARY OF THE INVENTION

The primary object of the present invention is to provide a rotating gear with limited angular movement to prevent a spindle from continuously being rotated in a range causing damages. To achieve the object, the rotating gear is comprised of a spindle pivotally disposed inside an object, at least one flange disposed on the periphery of one end of the spindle adjacent to the object, and an mobile limiter disposed on the same end of the spindle, where a first plate is extended perpendicularly from the periphery of one side of the limiter toward the spindle and a second plate is extended perpendicularly from the periphery of another side of the limiter toward the object. Thus, while the spindle is rotated, the flange is rotated and then engaged with the first plate to drive the limiter to rotate until the second plate touches against a stopper disposed on the object. As a result, the angular movement of the spindle 3 is restricted by the limiter 5, which prevents the spindle 3 from being continuously rotated in a range causing damages.

Another object of the present invention is to provide a rotating gear with limited angular movement to increase the rotating angle for the spindle. To achieve the object, at least one mobile member is disposed on one side of the limiter opposite to the spindle, and comprises of a retaining plate extended perpendicularly from the periphery of one side thereof toward the stopper. One end of the second plate of the limiter adjacent to the mobile member may contact with the periphery of the mobile member and be engaged with the retaining plate. Therefore, when the spindle is rotated, the flange is engaged with the first plate to drive the limiter, and then the second plate of the limiter is rotated and engaged with the retaining plate until the retaining plate touches against the stopper to stop the spindle from rotating. Thus, the range of rotating for the spindle will be increased while the number of the mobile member increases.

### BRIEF DESCRIPTION OF THE DRAWINGS

FIG. 1 is a schematic view showing a structure of a rotating gear of the prior art comprised of two objects and a spindle of the prior art;

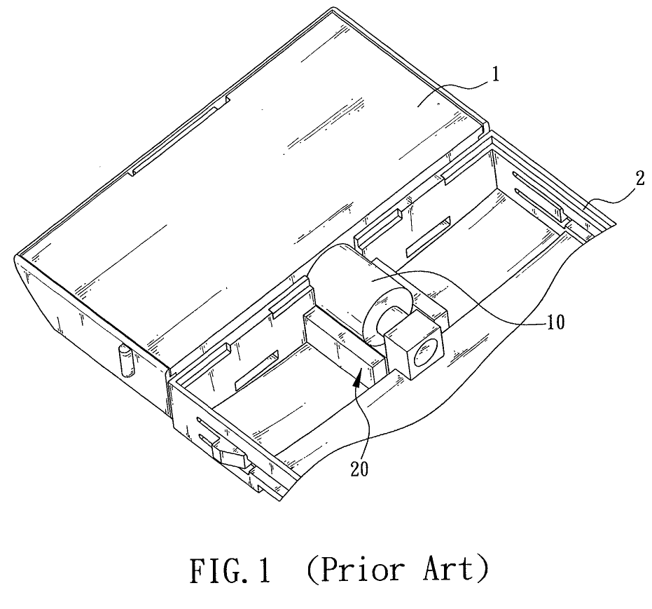

FIG. 2 is an exploded view of a preferred embodiment of the present invention comprised of two objects, a spindle, and a limiter;

FIG. 3 is a view showing an assembly of the preferred embodiment of the present invention of two objects, a spindle, and a limiter; and

FIG. 4 is a view showing an assembly of another preferred embodiment of the present invention comprised of two objects, a spindle, a limiter and a mobile member.

### DETAILED DESCRIPTION OF THE PREFERRED EMBODIMENTS

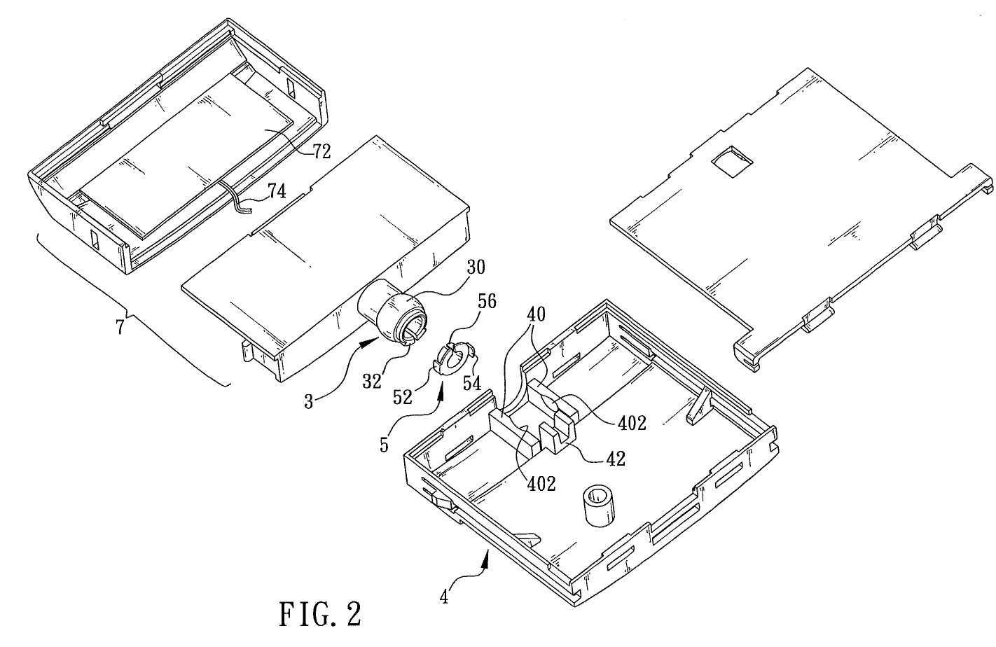

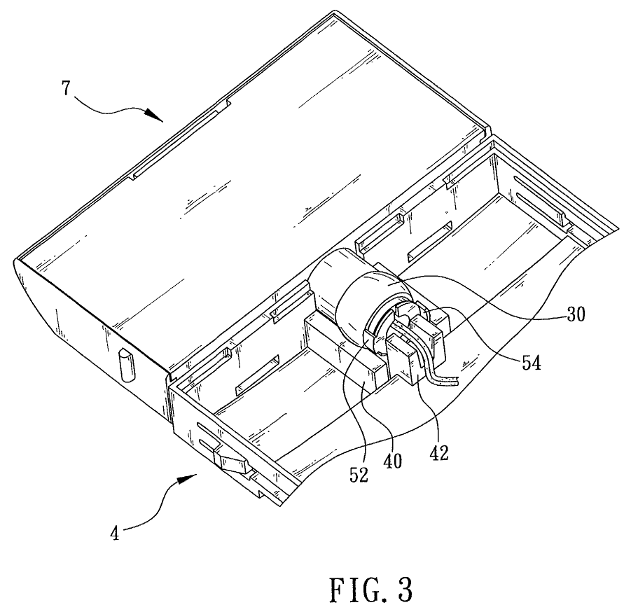

Referring to FIGS. 2 and 3, a preferred embodiment of the present invention is comprised of a spindle 3, an object 4, and a mobile limiter 5. Said spindle is pivotally disposed inside the object 4, where a curved protrusion 30 is provided on the circumference of the spindle 3, and at least one flange 32 is disposed on the periphery of one end of the spindle 3 adjacent to the object 4. The mobile limiter 5 is disposed on the same end of the spindle 3, where a first plate 52 is extended perpendicularly from the periphery of one side of the limiter 5 toward the spindle 3, and a second plate 54 is extended perpendicularly from the periphery of another side of the limiter 5 toward the object 4. Two guides 40 apart from each other are provided on the object 4 forming a proper space to accommodate the spindle 3. A concave 402 is provided on each of the guides 40 to accommodate the protrusion 30 of the spindle 3 and let the spindle 3 be properly positioned and rotated therein. Along with the rotation of the spindle 3, the flange 32 is rotated and then pushes the first plate 52 to rotate between said two guides 40. A stopper 42 is provided on the object 4 at the position adjacent to one end of each of the two guides 402 opposite to the limiter 5.

In the present invention, while the spindle 3 is rotated, the flange 32 is rotated and then engaged with the first plate 52 to drive the limiter 5 to rotate until the second plate 54 touches against the stopper 42. Therefore, the angular movement of the spindle 3 is restricted by the limiter 5, which prevents the spindle 3 from being continuously rotated in a range causing damages.

The rotating angle θ₁ of the spindle 3 corresponding to the limiter 5 can be obtained by the following formula (1):

θ₁=360°−θ₂−θ₃ (1)

wherein θ₂ relates to the degrees taken by the flange 32 on the spindle 3; and θ₃ relates to the degrees taken by the first plate 52 on the limiter 5. The rotating angle θ₄ of the limiter 5 corresponding to the stopper 42 can be calculated by the following formula (2):

θ₄=360°−θ₅−θ₆ (2)

wherein θ₅ relates to the degrees taken by the second plate 54 on the limiter 5; and θ₆ relates to the degrees taken by the stopper 42 on the limiter 5. Therefore, the maximal rotating angle θ of the spindle 3 will be represented by the following formula (3):

$$\begin{matrix}θ = {θ}_{1} + {θ}_{4} \\ = ( 360 ° - {θ}_{2} - {θ}_{3} ) + ( 360 ° - {θ}_{5} - {θ}_{6} ) \\ = 720 ° - {θ}_{2} - {θ}_{3} - {θ}_{5} - {θ}_{6}\end{matrix} \qquad ( 3 )$$

As solved from formula (3), the spindle 3 is restricted by the flange 32, the limiter 5 and the stopper 42, and is rotated within the range of a fixed degree (small than 640°).

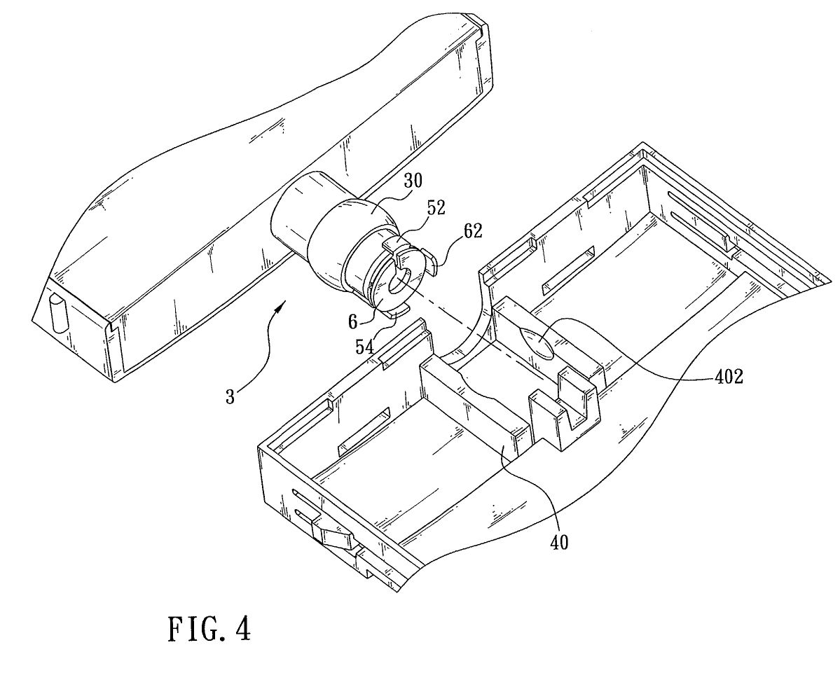

Now referring to FIG. 4, at least one mobile member 6 is disposed on one side of the limiter 5 opposite to the spindle 3. The mobile member 6 is similar to the limiter 5 also comprises of a retaining plate 62 extended perpendicularly from the periphery of one side thereof toward the stopper 42. One end of the second plate 54 of the limiter 5 adjacent to the mobile member 6 may contact with the periphery of the mobile member 6 and be engaged with the retaining plate 62. Therefore, when the spindle 3 is rotated, the flange 32 is rotated and then engaged with the first plate 52 to drive the limiter 5 to rotate together. Thus, the second plate 54 of the limiter 5 is rotated, and then engaged with the retaining plate 62 to rotate together until the retaining plate 62 touches against the stopper 42 to stop the spindle 3 from rotating. The maximal rotating angle θ′ for the spindle 3 is obtained by the following formula (4):

θ¹=θ+n(360°−θ₇) (4)

wherein θ₇ relates to the degrees taken by the retaining plate 62 on the mobile member 6 and n relates to the number of the mobile members available. Consequently, the rotating range for the spindle 3 increases as the number of the mobile number increases.

In another preferred embodiment of the present invention, said spindle 3, limiter 5 and mobile member 6 are all made in hollow. As illustrated in FIG. 2, a connection 56 extends perpendicularly from the inner periphery of the limiter 5 toward the inner periphery of the spindle 3. The connection 56 can just be inserted into and contacts with the inner periphery of the spindle 3 so as to connect the limiter 5 to the spindle 3 and enable the limiter 5 not to freely move inside the object 4. Another connection (not shown) extending perpendicularly from the inner periphery of the mobile member 6 toward the inner periphery of the limiter 5 can also be inserted into and contacts with the inner periphery of the limiter 5 so as to connect the mobile member 6 to the limiter 5 and enable the mobile member 6 to be kept from being freely moved inside the object 4. Accordingly, the spindle 3, the limiter 5 and the mobile member 6 are rotating along the same axis.

Now referring to FIG. 2, the object 4 relates to a casing of an electronic device containing a circuit board therein. One end of the spindle 3 away from the object 4 is fixed to another object 7, which also relates to a casing of another electronic device containing another circuit board 72. A signal wire 74 is disposed on the circuit board 72 and can be inserted through the center hole of the spindle 3 to transmit signals to circuit board of the object 4. When the spindle 3 is rotated, its rotating angle is restricted to prevent the signal wire 74 from being twisted out of limit and broken up. Therefore, the present invention avoids the spindle 3 from continuously rotating in a range causing damages.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A rotating gear with limited angular movement comprises of:
a spindle being pivotally disposed in an object, and having at least one flange provided on the periphery of one end thereof closer to said object;
a mobile limiter being disposed on said one end of said spindle, and having a first plate extended perpendicularly from the periphery of one side thereof toward said spindle, and a second plate extended perpendicularly from the periphery of another side thereof toward said object;
a stopper being provided on said object at the position adjacent to said second plate of said limiter; and
while said spindle being rotated, said flange is rotated and then engaged with said first plate to drive said limiter to rotate until said second plate touches against said stopper to stop the rotation of said spindle.

2. A rotating gear with limited angular movement as claimed in claim 1 further comprises at least one mobile member disposed on said another side of said limiter opposite to said spindle; each of said mobile member having a retaining plate extended perpendicularly from the periphery thereof toward said stopper, where said retaining plate may contact and be engaged with one end of said second plate of said limiter adjacent to said mobile member;
while said spindle being rotated, said flange is rotated and then engaged with said first plate to drive said second plate of said limiter to rotate and be engaged with said retaining plate to rotate together until said retaining plate touches against said stopper to stop said spindle from rotating.

3. A rotating gear with limited angular movement as claimed in claim 1, wherein said spindle, said limiter and said mobile member are made in hollow; where said limiter having a first connection extended from the inner periphery thereof toward the inner periphery of said spindle and able to be inserted into and contact with the inner periphery of said spindle so as to connect said limiter to said spindle and enable said limiter not to freely move inside said object.

4. A rotating gear with limited angular movement as claimed in claim, wherein said mobile member has a second connection extended from said inner periphery thereof toward the inner periphery of said limiter and able to be inserted into and contact with the inner periphery of said limiter so as to connect said mobile member to said limiter and enable said mobile member to be kept from being freely moved inside said object.

5. A rotating gear with limited angular movement as claimed in claim 1, 2, or 3 further comprises a curved protrusion being provided on the circumference of said spindle; two guides apart from each other being provided on said object forming a proper spacing to accommodate said spindle; a concave each provided on said guides to accommodate said protrusion of said spindle and let said spindle be properly positioned and rotated therein.

6. A rotating gear with limited angular movement as claimed in claim 1 further comprises another object fixed to one end of said spindle away from said object, and each of said objects is an electronic device having a circuit board therein and said circuit boards of said objects are connected by a signal wire through the center of said spindle to transmit signals between each other.
